(19) United States
(12) Patent Application Publication
(10) Pub. No.: US 2009/0184261 A1
(43) Pub. Date: Jul. 23, 2009

(54) IMAGING WITH A PLURALITY OF SOURCES TO A COMMON DETECTOR

(76) Inventor: Moshe Ein-Gal, Ramat Hasharon (IL)

Correspondence Address: David Klein;DEKEL PATENT LTD., Beit HaRof'im, 18 Menuha VeNahala Street, Room 27, REHOVOT, IL

(21) Appl. No.: 12/017,068

(22) Filed: Jan. 21, 2008

(51) Int. Cl. G21G 5/00

(52) U.S. Cl. 250/492.1

(57) ABSTRACT

An image scanning system including a plurality of spatially-distributed radiation beam sources, each source operative to emit a radiation beam characterized by a distinguishing parameter unique to each radiation beam source, and a common detector arranged with respect to the radiation beam sources such that the radiation beam sources emit their radiation beams onto the common detector which is operable to receive and distinguish the radiation beams on the basis of their respective distinguishing parameters so as to acquire partial projections sets of an object through which the radiation beams pass, wherein a union of the partial projections sets forms a projection set sufficient for reconstruction of an image of the object.

### FIELD OF THE INVENTION

The present invention relates generally to acquisition of CT projections using a multiplicity of radiation beam sources to a common detector, such as for CT or stereoscopic imaging.

### BACKGROUND OF THE INVENTION

In conventional computerized tomography (CT) for both medical and industrial applications, an x-ray fan beam and a linear array detector are employed to achieve two-dimensional axial imaging. Another technique for 3D computerized tomography is cone-beam x-ray imaging, in which an x-ray source projects a cone-shaped beam of x-ray radiation through the target object and onto a 2D area detector area. The target object is scanned, preferably over a 360° range, either by moving the x-ray source and detector in a scanning circle around the stationary object, or by rotating the object while the source and detector remain stationary. In either case, it is the relative movement between the source and object which accomplishes the scanning.

In both systems, radiation fan-beams and cone-beams, there is a diverging configuration of the beam. Due to magnification associated with the diverging geometry, the required detector size may be significantly larger than the imaged object. CT scanners, for example, incorporate detector arrays whose length is about twice the diameter of the patient cross-section. For cone-beam scanning, where two-dimensional detectors are required, the situation is more difficult. The size of present flat-panel detectors, e.g., amorphous silicon, is not adequate for many cone-beam CT applications.

To overcome this difficulty, sequential imaging using a single source and multiple spatially separated detectors has been taught. For example, U.S. Pat. No. 7,106,825 to Gregerson et al. describes apparatus and methods for reconstructing image data for a region are described. A radiation source and multiple one-dimensional linear or two-dimensional planar area detector arrays, located on opposed sides of a region angled generally along a circle centered at the radiation source, are used to generate scan data for the region from a plurality of diverging radiation beams, i.e., a fan beam or cone beam. Individual pixels on the discrete detector arrays from the scan data for the region are re-projected onto a new single virtual detector array along a continuous equiangular arc or cylinder or equilinear line or plane prior to filtering and back-projecting to reconstruct the image data.

Parallel configuration has also been proposed, i.e., using multiple pairs of sources and respective detectors to image the whole object, whereas the pairs are operable to image generally non-overlapping object portions. Such a system is described in applicant's copending U.S. patent application Ser. No. 11/553003, filed Oct. 26, 2006, the disclosure of which is hereby incorporated by reference.

In order to overcome the high cost associated with multiple detectors, sequential imaging has been taught (such as in U.S. Pat. No. 7,108,421 to Gregerson et al. and U.S. Pat. No. 4,907,157 to Uyama et al.) whereby the non-overlapping object portions are sequentially imaged by moving a single source-detector pair. The drawback of this configuration is the increase of imaging time and object motion artifacts.

### SUMMARY OF THE INVENTION

The present invention seeks to provide a system and method for acquisition of imaging projections using a multiplicity of radiation beam sources to a common detector, as is described more in detail hereinbelow. The invention has application in CT (computerized tomography) imaging scanning systems and stereoscopic imaging systems, as well as other imaging systems. For example, in stereoscopic imaging systems, the invention uses a single detector and at least two sources irradiating an overlapping region to obtain a stereoscopic image, and uses triangulation to obtain a 3D location of a marker in the region.

There is provided in accordance with an embodiment of the present invention an image scanning system including a plurality of spatially-distributed radiation beam sources, each source operative to emit a radiation beam characterized by a distinguishing parameter unique to each radiation beam source, and a common detector arranged with respect to the radiation beam sources such that the radiation beam sources emit their radiation beams onto the common detector which is operable to receive and distinguish the radiation beams on the basis of their respective distinguishing parameters so as to acquire partial projections sets of an object through which the radiation beams pass, wherein a union of the partial projections sets forms a projection set sufficient for reconstruction of an image of the object.

The radiation beams may respectively expose sub-volume portions of the object that are at least partially non-overlapping with respect to each other and wherein a union of the sub-volume portions covers the object's entire volume.

In accordance with one embodiment of the present invention, the distinguishing parameter includes time of exposure, and the radiation beams are triggered non-simultaneously and the detector is operable to completely recover from detecting a radiation beam prior to detecting a subsequent one.

In accordance with another embodiment of the present invention, the distinguishing parameter includes intensity modulation, and signals associated with the radiation beam sources that modulate the respective beam intensities have different temporal frequencies, and the detector is operable to filter and detect the respective temporal frequencies associated with the respective radiation beams.

In accordance with yet another embodiment of the present invention, the distinguishing parameter includes beam spectral content, wherein the detector detects and distinguishes between different beam spectral contents. For example, photon energies in the radiation beams may be different from each other and the detector separately detects the different photon energies.

In accordance with still another embodiment of the present invention, the distinguishing parameter includes a unique geometrical orientation of each radiation beam source relative to the detector, and the detector is operable to separately detect radiation beams reaching the detector from the orientations.

There is also provided in accordance with an embodiment of the present invention, a method for image scanning including emitting radiation beams from a plurality of spatially-distributed radiation beam sources onto a common detector, each radiation beam being characterized by a distinguishing parameter unique to each radiation beam source, and distinguishing the radiation beams on the basis of their respective distinguishing parameters so as to acquire partial projections sets of an object through which the radiation beams pass, wherein a union of the partial projections sets forms a projection set sufficient for reconstruction of an image of the object.

As above, the distinguishing parameters include, but are not limited to, time of exposure, intensity modulation, spectral content and geometrical orientation. The radiation beams may include cone beams, for example.

### BRIEF DESCRIPTION OF THE DRAWINGS

The present invention will be understood and appreciated more fully from the following detailed description taken in conjunction with the drawings in which:

FIG. 1 is a simplified pictorial illustration of an image scanning system, constructed and operative in accordance with an embodiment of the present invention; and

FIG. 2 is a simplified illustration of methods of using the image scanning system of FIG. 1, in accordance with embodiments of the present invention.

### DETAILED DESCRIPTION OF EMBODIMENTS

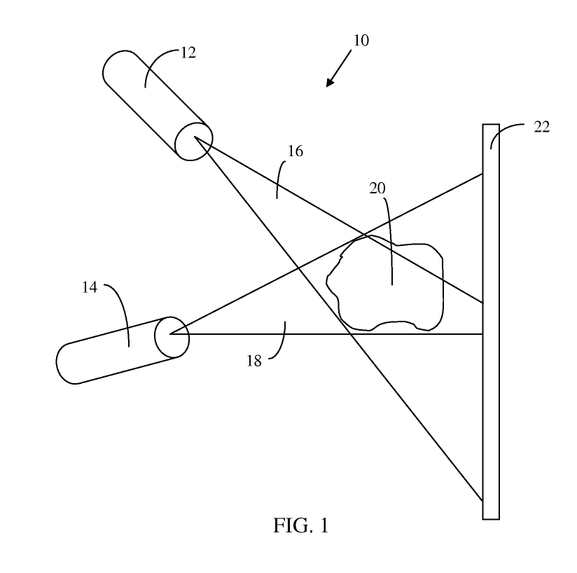

Reference is now made to FIG. 1, which illustrates an image scanning system 10 constructed and operative in accordance with an embodiment of the present invention.

Scanning system 10 includes a plurality of spatially-distributed radiation beam sources, such as sources 12 and 14 (any number of sources, two or greater, may be used). Radiation beam sources 12 and 14 respectively emit radiation beams 16 and 18. Each radiation beam is characterized by a distinguishing parameter unique to each radiation beam source. Examples of distinguishing parameters are explained below. The radiation beams 16 and 18 pass through an object 20, such as a target in a patient. Radiation beam sources 12 and 14 may be mounted on a rotating gantry (not shown) and the patient may be upright or supine on a treatment table or any other suitable position. As another alternative, radiation beam sources 12 and 14 may be stationary and the patient may be rotated by a rotatable table or seat.

A common detector 22 is arranged with respect to the radiation beam sources 12 and 14 such that the radiation beam sources 12 and 14 emit their radiation beams 16 and 18 onto common detector 22. Detector 22 is operable to receive and distinguish the radiation beams 16 and 18 on the basis of their respective distinguishing parameters so as to acquire partial projections sets of object 20 (through which the radiation beams 16 and 18 pass), wherein a union of the partial projections sets forms a projection set sufficient for reconstruction of an image of the object 20. For example, radiation beams 16 and 18 may respectively expose sub-volume portions of object 20 that are at least partially non-overlapping with respect to each other and wherein a union of the sub-volume portions covers the entire volume of object 20.

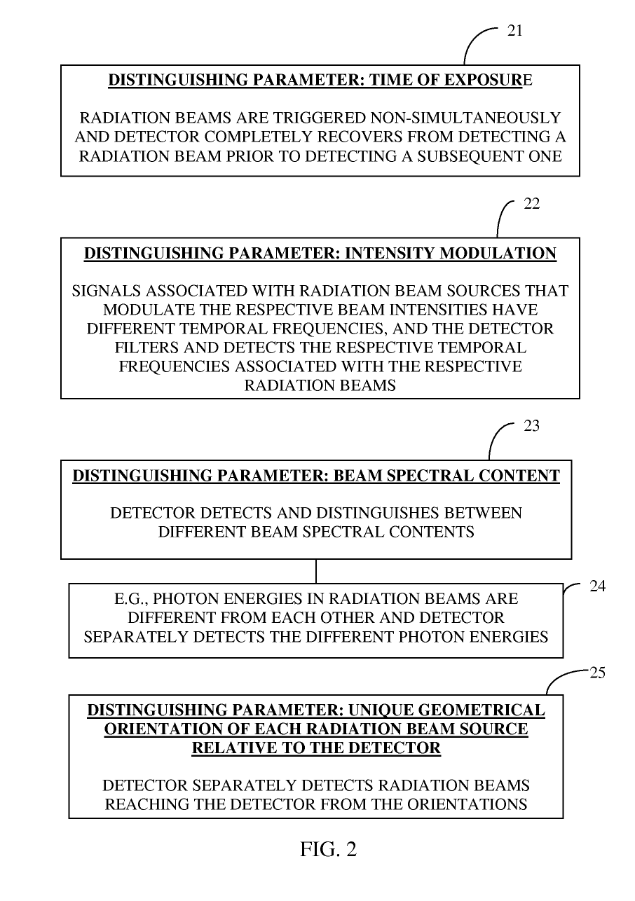

Reference is now made to FIG. 2, which illustrates methods of using the scanning system of FIG. 1, in accordance with embodiments of the present invention, and in accordance with different distinguishing parameters unique to each radiation beam source.

In accordance with one embodiment of the present invention, the distinguishing parameter includes time of exposure, and the radiation beams are triggered non-simultaneously and the detector is operable to completely recover from detecting a radiation beam prior to detecting a subsequent one (21).

In accordance with another embodiment of the present invention, the distinguishing parameter includes intensity modulation, and signals associated with the radiation beam sources that modulate the respective beam intensities have different temporal frequencies, and the detector is operable to filter and detect the respective temporal frequencies associated with the respective radiation beams (22).

In accordance with yet another embodiment of the present invention, the distinguishing parameter includes beam spectral content, wherein the detector detects and distinguishes between different beam spectral contents (23). For example, photon energies in the radiation beams may be different from each other and the detector separately detects the different photon energies (24).

In accordance with still another embodiment of the present invention, the distinguishing parameter includes a unique geometrical orientation of each radiation beam source relative to the detector, and the detector is operable to separately detect radiation beams reaching the detector from the orientations (25).

This may be accomplished in several ways. For example, for a one-dimensional detector, the pixel is divided in two such that each sub-pixel receives radiation from a different detector. (For example, the first sub-pixel of the detector has the energy impinging on it coming from a first source at a first angle and the second sub-pixel has the energy impinging on it coming from a second source at a second angle.) For a two-dimensional detector, one pixel may comprise four sub-pixels similar to a chess board, wherein the whites detect radiation from one source and blacks from the other.

It will be appreciated by persons skilled in the art that the present invention is not limited by what has been particularly shown and described hereinabove. Rather the scope of the present invention includes both combinations and subcombinations of the features described hereinabove as well as modifications and variations thereof which would occur to a person of skill in the art upon reading the foregoing description and which are not in the prior art.

What is claimed is:

1. An image scanning system comprising:
a plurality of spatially-distributed radiation beam sources, each source operative to emit a radiation beam characterized by a distinguishing parameter unique to each radiation beam source; and
a common detector arranged with respect to said radiation beam sources such that said radiation beam sources emit their radiation beams onto said common detector which is operable to receive and distinguish said radiation beams on the basis of their respective distinguishing parameters so as to acquire partial projections sets of an object through which said radiation beams pass, wherein a union of said partial projections sets forms a projection set sufficient for reconstruction of an image of said object.

2. The image scanning system according to claim 1, wherein said radiation beams respectively expose sub-volume portions of the object that are at least partially non-overlapping with respect to each other and wherein a union of said sub-volume portions covers said object's entire volume.

3. The image scanning system according to claim 1, wherein said distinguishing parameter comprises time of exposure, and said radiation beams are triggered non-simultaneously and said detector is operable to completely recover from detecting a radiation beam prior to detecting a subsequent one.

4. The image scanning system according to claim 1, wherein said distinguishing parameter comprises intensity modulation, and wherein signals associated with said radiation beam sources that modulate the respective beam intensities have different temporal frequencies, and said detector is operable to filter and detect the respective temporal frequencies associated with the respective radiation beams.

5. The image scanning system according to claim 1, wherein said distinguishing parameter comprises beam spectral content, wherein said detector detects and distinguishes between different beam spectral contents.

6. The image scanning system according to claim 5, wherein photon energies in said radiation beams are different from each other and said detector is operable to separately detect the different photon energies.

7. The image scanning system according to claim 1, wherein said distinguishing parameter comprises a unique geometrical orientation of each radiation beam source relative to said detector, and said detector is operable to separately detect radiation beams reaching said detector from said orientations.

8. The image scanning system according to claim 1, wherein said radiation beams comprise cone beams.

9. A method for image scanning comprising:
emitting radiation beams from a plurality of spatially-distributed radiation beam sources onto a common detector, each radiation beam being characterized by a distinguishing parameter unique to each radiation beam source; and
distinguishing said radiation beams on the basis of their respective distinguishing parameters so as to acquire partial projections sets of an object through which said radiation beams pass, wherein a union of said partial projections sets forms a projection set sufficient for reconstruction of an image of said object.

10. The method according to claim 9, comprising using said radiation beams to respectively expose sub-volume portions of the object that are at least partially non-overlapping with respect to each other and wherein a union of said sub-volume portions covers said object's entire volume.

11. The method according to claim 9, wherein said distinguishing parameter comprises time of exposure, and said radiation beams are triggered non-simultaneously and said detector completely recovers from detecting a radiation beam prior to detecting a subsequent one.

12. The method according to claim 9, wherein said distinguishing parameter comprises intensity modulation, and wherein signals associated with said radiation beam sources that modulate the respective beam intensities have different temporal frequencies, and said detector filters and detects the respective temporal frequencies associated with the respective radiation beams.

13. The method according to claim 9, wherein said distinguishing parameter comprises beam spectral content, wherein said detector detects and distinguishes between different beam spectral contents.

14. The method according to claim 13, wherein photon energies in said radiation beams are different from each other and said detector separately detects the different photon energies.

15. The method according to claim 9, wherein said distinguishing parameter comprises a unique geometrical orientation of each radiation beam source relative to said detector, and said detector separately detects radiation beams reaching said detector from said orientations.
